(19) United States
(12) Patent Application Publication
(10) Pub. No.: US 2026/0214453 A1
(43) Pub. Date: Jul. 23, 2026

(54) ESIM-BASED USER DEVICE CONTROL METHOD, APPARATUS AND USER DEVICE

(71) Applicant: GIESECKE+DEVRIENT (JIANGXI) TECHNOLOGY CO., LTD., NanChang (CN)

(72) Inventor: Weixiang ZHA, NanChang (CN)

(21) Appl. No.: 19/453,655

(22) Filed: Jan. 20, 2026

(30) Foreign Application Priority Data
Jan. 17, 2025 (CN) 2025100828231

(51) Int. Cl. H04W 12/30; G06F 21/57

(52) U.S. Cl. CPC H04W 12/35; G06F 21/57

(57) ABSTRACT

An eSIM-based user device control method, apparatus and user device are provided. The method includes: receiving an encrypted application access request, carrying an application unique identification of a target application, an application signature information thereof and an access object information of the target access object; decrypting the application access request to obtain a decrypted application access request; verifying the application signature information in the decrypted application access request based on the pre-stored signature certificate of the target application; performing, if the verification is successful, the permission validation on the application access request based on the application permission control information to obtain the permission validation result, where the result is used to indicate whether the target application has the permission to access the target access object; and returning the permission validation results for the application access request, which may achieve secure control and management of the access permission of the application.

### TECHNICAL FIELD

The present application belongs to the field of telecommunication technology, and in particular relates to an eSIM-based user device control method, apparatus and user device.

### BACKGROUND

During the process of installing or running an application on a user device, the application can request to obtain certain permission information of the user device, such as the permission to access its identifier information (i.e., the mobile number), the permission to obtain its biometric information (i.e., the fingerprint information and the facial information), the permission to obtain its content information (i.e., photos, videos, and text messages), the permission to obtain functional information (i.e., shooting with cameras), and the like.

Accordingly, security issues may arise if those permissions of the application cannot be properly managed.

### SUMMARY

The embodiments of the present application provide an eSIM-based user device control method, apparatus and user device, by which the access permissions of the applications can be managed and controlled securely.

In a first aspect, an eSIM-based user device control method is provided in the embodiments of the present application. The method is applied to an eSIM, the eSIM may pre-store the application permission control information, and the application permission control information may comprise an application unique identification, an access object information, and a permission information corresponding to the application unique identification. The method may comprise: receiving an encrypted application access request, where the application access request carries an application unique identification of the target application, an application signature information of the target application and an access object information of the target access object; decrypting the application access request to obtain a decrypted application access request; verifying the application signature information in the decrypted application access request based on the pre-stored signature certificate of the target application; performing, in a case where the verification is successful, a permission validation on the application access request based on the application permission control information to obtain a permission validation result, where the permission validation result can be used to indicate whether the target application has the permission to access the target access object; and returning the permission validation result for the application access request.

In an alternative implementation of the first aspect, returning the permission validation result for the application access request may comprise: signing and encrypting the permission validation result to obtain the signed and encrypted permission validation result; sending the signed and encrypted permission validation result to the target application, so that the target application decrypts the signed and encrypted permission validation result, verifies the signature information in the decrypted permission validation result based on the pre-stored signature certificate of the eSIM; and obtaining the permission validation result after the verification is successful.

In an alternative implementation of the first aspect, the method may further comprise: receiving an encrypted control information update request, where the control information update request carries at least the application unique identification of the target application, the access object information to be updated, and the permission information to be updated; decrypting the control information update request to obtain a decrypted control information update request; and updating the application permission control information based on the decrypted control information update request.

In an alternative implementation of the first aspect, the control information update request is sent by the server through the user device management system, and receiving the encrypted control information update request may comprise: receiving an encrypted device authentication instruction, where the device authentication instruction carries a signature information of the user device management system; decrypting the device authentication instruction to obtain the signature information of the user device management system; verifying the signature information of the user device management system; and establishing, in a case where the verification is successful, a secure channel with the server through the user device management system, where the secure channel is used to receive the control information update request.

In an alternative implementation of the first aspect, the process of the eSIM pre-storing the application permission control information may comprise: receiving an encrypted application permission configuration request, where the application permission configuration request carries the application permission control information, the application permission configuration request is sent by the server through the user device management system, and the application permission control information is generated by the server based on the device access request sent by the target application; and storing the application permission control information.

In a second aspect, an eSIM-based user device control method is provided in the embodiments of the present application. The method is applied to a target application, the target application runs on a user device, the user device may comprise an eSIM, and the eSIM pre-stores an application permission control information, where the application permission control information may comprise the unique application identification, the access object information and the permission information corresponding to the unique application identification. The eSIM-based user device control method may comprise: sending an encrypted application access request to the eSIM, where the application access request carries an application unique identification of the target application, an application signature information of the target application and an access object information of the target access object, so that the eSIM may decrypt the application access request to obtain the decrypted application access request, verify the application signature information in the decrypted application access request based on the pre-stored signature certificate of the target application, and perform, in a case where the verification is successful, the permission validation on the application access request based on the application permission control information to obtain the permission validation result; and accessing the target access object in a case where the permission validation result indicates that the target application has the permission to access the target access object.

In an alternative implementation of the second aspect, before accessing the target access object, the method may further comprise: receiving a signed and encrypted permission validation result sent by the eSIM.

In an alternative implementation of the second aspect, the method may further comprise: sending an access permission application request to the server in a case where the permission validation result indicates that the target application does not have the permission to access the target access object, where the access permission application request carries at least the application unique identification and the access object information of the target application, so that the server may send a control information update request to the user device management system, and the control information update request can be used to enable the user device management system to update the application permission control information that is pre-stored by the eSIM.

In an alternative implementation of the second aspect, accessing the target access object may comprise: obtaining the access permission data in a case where the permission validation result is used to indicate that the target application has the permission to access the target access object; generating an access instruction based on the access permission data and the application signature information of the target application; sending the access instruction to the user device management system, so that the user device management system may verify the application signature information in the access instruction based on the pre-stored signature certificate of the target application, and sending, in a case where the verification is successful, the data corresponding to the target access object to the target application based on the obtained access permission data; and receiving the data of the target access object.

In a third aspect, an eSIM-based user device control method is provided in the embodiments of the present application. The method is applied to a user device, the user device runs a target application, the user device comprises an eSIM, and the eSIM pre-stores application permission control information, where the application permission control information may comprise an application unique identification, an access object information and a permission information corresponding to the application unique identification. The method may comprise: receiving an access instruction sent by a target application; obtaining the access permission data based on the access instruction, where the access permission data is obtained in a case where the permission validation result indicates that the target application has the permission to access the target access object, and the permission validation result is obtained by decrypting, by the eSIM, the application access request to obtained the decrypted application access request, verifying the application signature information in the decrypted application access request based on the pre-stored signature certificate of the target application, and performing, in a case where the verification is successful, a permission validation based on the application permission control information; and sending the data of the target access object to the target application in a case where the access permission data is obtained.

In an alternative embodiment of the third aspect, the access instruction at least carries an application signature information of the target application, and obtaining the access permission data based on the access instruction may comprise: verifying the application signature information in the access instruction based on a pre-stored signature certificate of the target application; and determining, in a case where the verification is successful, whether the access permission data exists in the access instruction; and obtaining the access permission data in a case where the access permission data exists in the access instruction.

In an alternative embodiment of the third aspect, the method may further comprise: receiving an encrypted control information update request, where the control information update request is used to update the application permission control information that is pre-stored by the eSIM; and updating the application permission control information that is pre-stored in the eSIM based on the control information update request.

In an alternative embodiment of the third aspect, receiving the encrypted control information update request may comprise: sending an encrypted device authentication instruction to the eSIM, so that the eSIM may decrypt the device authentication instruction, obtain the signature information of the user device management system, and verify the signature information of the user device management system based on the pre-stored signature certificate of the user device management system; receiving the encrypted response data sent by the eSIM, where the response data carries the signature information of the eSIM; verifying the signature information in the response data based on the pre-stored signing certificate of the eSIM; and establishing, in a case where the verification is successful, a secure channel with the server, where the secure channel is used to receive the control information update request.

In a fourth aspect, an eSIM-based user device control system is provided in the embodiments of the present application. The system may comprise a user device and a server, the user device runs a target application, the user device comprises an eSIM, the eSIM pre-stores an application permission control information, and the application permission control information comprises an application unique identification, an access object information and a permission information corresponding to the application unique identification; wherein the server is used to generate the application permission control information based on the device access request sent by the target application, and send the application permission control information to the eSIM through the user device management system; the eSIM is used to receive the encrypted application access request, decrypt the application access request to obtain the decrypted application access request, and verify the application signature information in the decrypted application access request based on the pre-stored signature certificate of the target application, perform in a case where the verification is successful, a permission validation on the application access request based on the application permission control information to obtain the permission validation result, where the application access request carries the application unique identification of the target application, the application signature information of the target application and the access object information of the target access object, and where the permission validation result is used to indicate whether the target application has the permission to access the target access object.

In a fifth aspect, an eSIM-based user device control apparatus is provided in the embodiments of the present application. The apparatus is applied to an eSIM, the eSIM pre-stores an application permission control information, and the application permission control information comprise an application unique identification, an access object information and a permission information corresponding to the application unique identification, The eSIM-based user device control apparatus may comprise: a first receiving module for receiving an encrypted application access request, where the application access request carries an application unique identification of the target application, an application signature information of the target application, and an access object information of the target access object; a decryption module for decrypting the application access request to obtain the decrypted application access request; a verification module for verifying the application signature information in the decrypted application access request based on the pre-stored signature certificate of the target application; a validation module for performing, in a case where the verification is successful, a permission validation on the application access request based on the application permission control information to obtain a permission validation result, where the permission validation result is used to indicate whether the target application has the permission to access the target access object; and a return module for returning the permission validation result for the application access request.

In a sixth aspect, an eSIM-based user device control apparatus is provided in the embodiments of the present application. The apparatus is applied to a target application, the target application runs on a user device, the user device comprises an eSIM, and the eSIM pre-stores application permission control information, and the application permission control Information comprises an application unique identification, an access object information and a permission information corresponding to the application unique identification. The eSIM-based user device control apparatus may comprise: a first sending module for sending an encrypted application access request to the eSIM, where the application access request carries the application unique identification of the target application, the application signature information of the target application and the access object information of the target access object, so that the eSIM may decrypt the application access request to obtain the decrypted application access request, verify the application signature information in the decrypted application access request based on the pre-stored signature certificate of the target application, perform, in a case where the verification is successful, a permission validation on the application access request based on the application permission control information, and obtain a permission validation result; and an access module for accessing the target access object in a case where the permission validation result indicates that the target application has the permission to access the target access object.

In a seventh aspect, an eSIM-based user device control apparatus is provided in the embodiments of the present application. The apparatus is applied to the user device, the user device runs a target application, the user device comprises an eSIM, the eSIM pre-stores an application permission control information, and the application permission control information comprises an application unique identification, an access object information and a permission information corresponding to the application unique identification. The eSIM-based user device control apparatus may comprise: a second receiving module for receiving the access instruction sent by the target application; an acquisition module for obtaining the access permission data based on the access instruction, where the access permission data is obtained in a case where the permission validation result indicates that the target application has the permission to access the target access object, and the permission validation result is obtained by decrypting, by the eSIM, the application access request to obtain the decrypted application access request, verifying the application signature information in the decrypted application access request based on the pre-stored signature certificate of the target application, and performing, in a case where the verification is successful, the permission validation on the application access request based on the application permission control information; and a second sending module for sending the data of the target application object to the target application in a case where the access permission data is obtained.

In an eighth aspect, a computer storage medium is provided in the embodiments of the present application, storing computer program instructions thereon which, when executed by a processor, may implement any of the first aspect, the second aspect, or the third aspect of the eSIM-based user device control method.

In a ninth aspect, a computer program product is provided in the embodiments of the present application, with the instructions therein which, when executed by a processor of an electronic device, may cause the electronic device to perform any of the first aspect, the second aspect, or the third aspect of the eSIM-based user device control method.

In a tenth aspect, a user device is provided in the embodiments of the present application, which comprises an eSIM, a processor, and a memory storing computer program instructions. When the processor executes the computer program instructions, it implements any of the first aspect, the second aspect, or the third aspect of the eSIM-based user device control method.

In the eSIM-based user device control method in the embodiment of the present application, the eSIM decrypts the received encrypted application access request to obtain the decrypted application access request, and since the application access request carries the application signature information of the target application, based on the pre-stored signature certificate of the target application, the application signature information in the application access request can be verified, so that the identity of the target application can be verified relatively quickly, preventing the illegal applications from accessing the user device. In a case where the identity verification of the target application is successful, based on the application permission control information that is pre-stored in the eSIM, whether the target application has the permission to access the target access object can be verified, the permission validation result can be obtained, and the permission validation result can be returned for the application access request, preventing the target application from tampering with its own access permissions, that is, prevent the target application from accessing the target access object without the permission to access the target access object, achieving secure control and management of the application access permissions. It can be seen that the eSIM-based user device control method of the present application can encrypt and sign the communication information between the target application and the eSIM, preventing the communication information from being tampered with and leaked, and may verify the access permissions for the application by utilizing the pre-stored application permission control information, achieving secure management and control of the permissions for the target application. In addition, by presetting the application permission control information in the eSIM, different applications can be flexibly provided with different access permissions, achieving differentiated control and management of the permissions for the application.

### BRIEF DESCRIPTION OF DRAWINGS

To explain the technical solution of the embodiments of the present application more clearly, the following will briefly introduce the accompanying drawings required to be used in the embodiments of the present application. For those ordinary skilled in the art, other drawings can be obtained based on these drawings without any creative works.

FIG. 1 is a schematic architectural diagram of the eSIM-based user device control

system, provided in an embodiment of the present application;

FIG. 2 is a schematic flowchart of the eSIM-based user device control method, provided in an embodiment of the present application;

FIG. 3 is a schematic diagram of verifying the application signature information of a target application, provided in an embodiment of the present application;

FIG. 4 is a schematic diagram of whether the target application has the permission to access a target access object, provided in an embodiment of the present application;

FIG. 5 is a schematic flowchart of updating the application permission control information of the eSIM, provided in an embodiment of the present application;

FIG. 6 is a schematic flowchart of the eSIM-based user device control method, provided in another embodiment of the present application;

FIG. 7 is a schematic flowchart of determining the permission validation results based on the application permission control information, provided in an embodiment of the present application;

FIG. 8 is a schematic flowchart of the eSIM-based user device control method, provided in yet another embodiment of the present application;

FIG. 9 is a schematic diagram of the interactions between the target application, server, user device management system and the eSIM, provided in an embodiment of the present application;

FIG. 10 is a schematic diagram of the interaction between the target application, the user device management system and the eSIM, provided in an embodiment of the present application;

FIG. 11 is a schematic structural diagram of the eSIM-based user device control apparatus, provided in an embodiment of the present application;

FIG. 12 is a schematic structural diagram of the eSIM-based user device control apparatus, provided in another embodiment of the present application;

FIG. 13 is a schematic structural diagram of the eSIM-based user device control apparatus, provided in yet another embodiment of the present application;

FIG. 14 is a schematic structural diagram of the user device, provided in an embodiment of the present application.

Wherein, the above-mentioned drawings may include the following reference numerals:

100. eSIM; 101. User device; 102. Target application; 103. Server; 1110. First receiving module; 1120. Decryption module; 1130. Verification module; 1140. Validation module; 1150. Return module; 1210. First sending module; 1220. Access module; 1310. Second receiving module; 1320. Obtaining module; 1330. Second sending module; 1401. Processor; 1402. Memory; 1403. Communication interface; 1410. Bus.

### DETAILED DESCRIPTION

The features and exemplary embodiments of various aspects of the present application will be described in detail below. In order to make the purpose, technical solutions and advantages of the present application clearer, the present application will be further described in detail below with reference to the accompanying drawings and the specific embodiments. It should be understood that the specific embodiments described here are only intended to explain the present application, but not to limit the present application. It will be apparent to one skilled in the art that the present application may be practiced without some of these specific details. The following description of the embodiments is merely intended to provide a better understanding of the present application by illustrating examples of the present application.

It should be noted that in this article, the relational terms such as the first and the second are only used to distinguish one entity or operation from another entity or operation, and do not necessarily require or imply the relationship between these entities or operations. There can be any such actual relationships or sequences. Moreover, the terms "comprises," "comprising," or any other variation thereof, may be intended to cover a non-exclusive inclusion, such that a process, method, object, or device that comprises a series of elements may not only include those elements, but also other elements not expressly listed or inherent to such process, method, object, or device. Without further constraints, an element defined by the statement "comprises..." does not exclude the presence of any additional identical element in the process, method, object, or device that includes the stated element.

During the process of installing or running an application on a user device, the application can request to obtain certain permission information of the user device, such as the permission to access its identifier information (i.e., the mobile number), the permission to obtain its biometric information (i.e., the fingerprint information and the facial information), the permission to obtain its content information (i.e., photos, videos, and text messages), the permission to obtain functional information (i.e., shooting with cameras), and the like.

Accordingly, if those permissions of the application are not properly managed, security issues may arise.

For example, when updating the application or obtaining the device information on the user device, it is necessary to rely on the permission provided by the user device management system for the application, but it cannot differentially manage and control the permission to access the user device for the application. In addition, the related keys of the user device which are stored in the related storage area of the user device are correspond to a low security level, making it impossible to manage and control the permissions for the application securely.

The embodiments of the present application provide an eSIM-based user device control method, apparatus and user device. The eSIM may decrypt the received encrypted application access request and may obtain a decrypted application access request. Since the application signature information of the target application is carried in the application access request, the application signature information in the application access request can be verified based on a pre-stored signature certificate of the target application. This can relatively quickly verify the identity of the target application and prevent illegal applications from accessing the user device. In a case where the identity verification of the target application is successful, based on the application permission control information that is pre-stored by the eSIM, whether the target application has the permission to access the target access object can be validated, a permission validation result can be obtained, and the permission validation result can be returned for the application access request. This may prevent the target application from tampering with its own access permissions, that is, prevent the target application from accessing the target access object without the permission to access the target access object, achieving secure management and control of the access permissions for the application. It can be seen that the eSIM-based user device control method of the present application may encrypt and sign the communication information between the target application and the eSIM, preventing the communication information from being tampered with and leaked, and may verify the access permissions for the application by utilizing the pre-stored application permission control information, achieving secure management and control of the permissions for the target application. In addition, by presetting the application permission control information in the eSIM, different applications can be flexibly provided with different access permissions, achieving differentiated control and management of the permissions for the application.

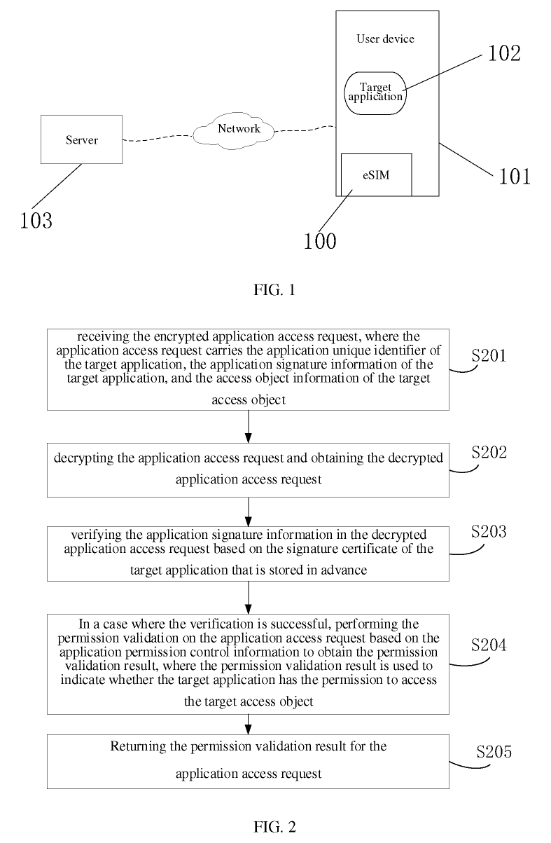

For ease of understanding, firstly, the eSIM-based user device control system of the present application shall be introduced. As shown in FIG. 1, the eSIM-based user device control system provided in the embodiment of the present application may comprise a user device 101 and a server 103. The target application 102 runs on the user device 101, and the user device 101 may comprise an eSIM 100. The eSIM 100 may pre-store the application permission control information, and the application permission control information may comprise an application unique identification, as well as an access object information and a permission information corresponding to the application unique identification.

Wherein

The server 103 may be used to generate the application permission control information based on the device access request sent by the target application 102, and further send the application permission control information to the eSIM 100 through the user device management system.

The eSIM 100 may be used to receive the encrypted application access request and decrypt the application access request to obtain the decrypted application access request. The application signature information in the decrypted application access request can be verified based on the pre-stored signature certificate of the target application 102. In a case where the verification is successful, the application access request can be validated based on the application permission control information to obtain a permission validation result. The application access request carries the application unique identification of the target application 102, the application signature information of the target application 102 and the access object information of the target access object. The permission validation result is used to indicate whether the target application 102 has the permission to access the target access object.

Alternatively, the eSIM (Embedded SIM, eSIM), i.e., an electronic SIM card, is a data file. In a practical application, the eSIM may be downloaded to the user device through a network.

Alternatively, the signature certificate is a digital certificate, which is mainly used to verify the authenticity and integrity of the digital signature. The signature information is a special information used to verify the identity and ensure the content integrity. The signed information in the digital domain can be a digital signature.

Alternatively, the encryption is the process of converting information into ciphertext through a specific algorithm. Specifically, the encryption in the embodiments of the present application can be symmetric encryption or asymmetric encryption. The symmetric encryption uses the same key for the encryption and the decryption. The asymmetric encryption may comprise a public key and a private key, where the public key is used to encrypt the information, and the private key is used to decrypt the encrypted information.

Alternatively, the target access objects in the embodiments of the present application may comprise user data, system information, and network resources. For example, the user data may comprise, but are not limited to, the personal information. The system resources may comprise, but are not limited to, the hardware resources and the storage resources, where the hardware resources can be the camera and microphone of the user device, etc., and the storage resources can be the application configuration information, the cached data, the files downloaded by the user, etc. The network resources can be the software update packages, messages or news, etc.

In the following description, the process of pre-storing the application permission control information by the eSIM shall be introduced.

There can be various implementations for pre-storing the application permission control information in the eSIM.

In one embodiment, the application permission control information can be stored in the eSIM through the user device.

In another embodiment, the application permission control information can be stored in the eSIM through the server. Specifically, the eSIM may receive an encrypted application permission configuration request. The application permission configuration request carries the application permission control information. The application permission configuration request is sent by the server through the user device management system, and the application permission control information can be generated by the server based on the device access request sent by the target application. Then, the application permission control information can be stored.

That is to say, the target application sends a device access request to the server, while the device access request carries the application unique identification of the target application. When the server receives the device access request sent by the target application, it may determine the application permission control information of the target application based on the application unique identification of the target application. After determining the application permission control information, the server may generate the application permission configuration request based on the application permission control information and encrypt the application permission configuration request. The server sends the encrypted application permission configuration request to the user device management system. The user device management system sends the application permission configuration request to the eSIM. The eSIM may decrypt the encrypted application permission configuration request, obtain the application permission control information after the decryption, and store the application permission control information.

Through the server, the application permission control information can be stored in the eSIM, which may facilitate the server to centrally manage and control the permissions of different user devices and different target applications. At the same time, through the application permission control information, different access permissions can also be provided for different applications, realizing differentiated management of the application access permissions. In addition, if the application permission control information needs to be updated later, the application permission control information can be updated relatively quickly through the server.

Taking the eSIM as the executing subject in the following description, the eSIM-based user device control method in the embodiment of this application will be introduced.

FIG. 2 is a schematic flowchart of the eSIM-based user device control method provided in an embodiment of the present application. As shown in FIG. 2, the eSIM-based user device control method provided in the embodiment of the present application may comprise steps S201 to S205.

In step S201, the encrypted application access request is received, where the application access request carries the application unique identification of the target application, the application signature information of the target application, and the access object information of the target access object.

Alternatively, the application unique identification can be an application identifier (Application Identifier, APP ID), or a package name (Package Name), etc.

Alternatively, the application signature information of the target application is the signature information of the target application.

There can be various implementations for the eSIM to receive the encrypted application access request.

In one embodiment, the target application sends the encrypted application access request to the user device management system, which then forwards the encrypted application access request to the eSIM.

In another implementation, in a case where the target application can communicate with the eSIM, the target application can send the encrypted application access request to the eSIM.

For ease of understanding, an example is introduced below to explain the application access request. If the target application needs to access the “microphone” on the user device, the information carried in the application access request may comprise the application unique identification of the target application, such as the APP ID, the application signature information of the target application, and the target access object, such as the microphone.

In step S202, the application access request is decrypted to obtain a decrypted application access request.

After decrypting the application access request, the application unique identification, application signature information and target access object of the target application in the application access request can be obtained.

In step S203, the application signature information in the decrypted application access request can be verified based on the pre-stored signature certificate of the target application.

Based on the signature certificate of the target application stored in the eSIM, the application signature information in the received application access request is successful, so as to relatively quickly and accurately verify the identity of the target application, prevent illegal applications from accessing the user device, and thus prevent the leakage of data information of the user device, ensuring the security of the user device.

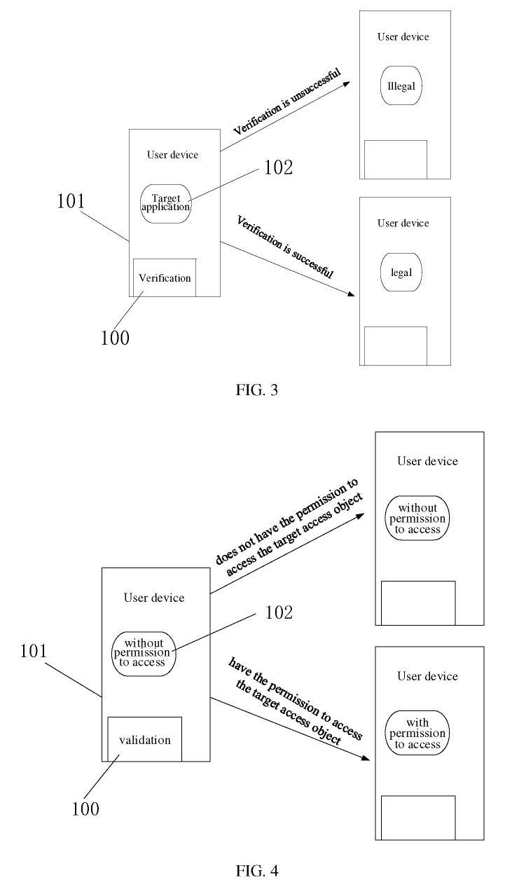

As shown in FIG. 3, the eSIM 100 verifies the application signature information in the decrypted application access request based on the pre-stored signature certificate of the target application 102. In a case where the verification is unsuccessful, the eSIM 100 can sign and encrypt the information that “verification is unsuccessful”. In a case where the verification is successful, the eSIM 100 can sign and encrypt the information that “verification is successful”.

In one embodiment, as shown in FIG. 3, the eSIM 100 can send the signed and encrypted the information that “verification is unsuccessful” to the target application through the user device 101, so that the wording “illegal” can be displayed on the target application 102. Alternatively, the eSIM 100 sends the signed and encrypted “verification is unsuccessful” to the target application, so that the wording “illegal” can be displayed on the target application 102.

In another embodiment, as shown in FIG. 3, the eSIM 100 can send the signed and encrypted the information that “verification is successful” to the target application through the user device 101, so that a “legal” can be displayed on the target application 102. Alternatively, the eSIM 100 sends the signed and encrypted the information that “verification is successful” to the target application 102 so that the wording “legal” can be displayed on the target application 102.

In step S204, in a case where the verification is successful, based on the application permission control information, a permission validation shall be performed on the application access request to obtain a permission validation result, and the permission validation result is used to indicate whether the target application has the permission to access the target access object.

Decrypting the application access request may obtain the application unique identification in the application access request and the access object information of the target access object. Then, based on the application unique identification in the application access request and the access object information of the target access object, it can be relatively quickly determined whether the target application has the permission to access the target access object from the pre-stored application permission control information in the eSIM.

In step S205, the permission validation result is returned for the application access request.

After obtaining the permission validation result based on the application permission control information and the application unique identification in the application access request, the eSIM returns the permission validation result to the target application in response to the application access request.

In the embodiment of the present application, in a case where the identity verification of the target application is successful, based on the application permission control information that is pre-stored by the eSIM, whether the target application has the permission to access the target access object can be validated, a permission validation result can be obtained, and the permission validation result can be returned for the application access request. This may prevent the target application from tampering with its own access permissions, that is, prevent the target application from accessing the target access object without the permission to access the target access object, achieving secure management and control of the access permissions for the application. By presetting the application permission control information in the eSIM, different applications can be flexibly provided with different access permissions, realizing differentiated control and management of the application permissions.

In an alternative embodiment of the present application, returning the permission validation result for the application access request may comprise: signing and encrypting the permission validation result to obtain the signed and encrypted permission validation result; sending the signed and encrypted permission validation result to the target application, so that the target application decrypts the signed and encrypted permission validation result; verifying the signature information in the decrypted permission validation result based on the pre-stored signature certificate for the eSIM; and after the verification is successfuls, obtaining the permission validation result.

The eSIM encrypts and signs the permission validation result, and sends the encrypted and signed permission validation result to the target application. This may prevent the permission validation result from being tampered with and leaked during the communication process.

Alternatively, the eSIM can return the permission validation result to the user device management system, and then the user device management system sends the signed and encrypted permission validation result to the target application.

As shown in FIG. 4, the eSIM sends the signed and encrypted permission validation result to the target application. The target application verifies the signature information in the decrypted permission validation result based on the pre-stored signature certificate for the eSIM. After the verification is successful, the target application can obtain the permission validation result. In a case where the permission validation result indicates that the target application does not have the permission to access the target access object, “no permission to access” can be displayed on the target application. In a case where the permission validation result indicates that the target application has the permission to access the target access object, “access with permission” can be displayed on the target application.

In one embodiment, in a case where the permission validation result indicates that the target application has the permission to access the target access object, the target application can obtain the access permission data based on the permission validation result. An access instruction is generated based on the access permission data and the application signature information of the target application. Afterwards, the target application may access the target access object on the user device based on the access instruction.

In another embodiment, in a case where the permission validation result indicates that the target application does not have the permission to access the target access object, the user can authorize the target application to apply to the server or the user device for the permission to access the target access object through the display interface, so that the server or the user device updates the application permission control information on the eSIM.

In yet another embodiment, the user can initially authorize the target application, so that In a case where the permission validation result indicates that the target application does not have the permission to access the target access object, the user can apply to the server or the user device to access the target access object, so that the server or the user device may update the application permission control information on the eSIM.

In an alternative embodiment of the present application, the eSIM-based user device control method in the embodiment of the present application further comprises: receiving an encrypted control information update request, where the control information update request at least carries the application unique identification of the target application, the access object information to be updated and the permission information to be updated; decrypting the control information update request to obtain a decrypted control information update request; and updating the application permission control information based on the decrypted control information update request.

Since the control information update request comprises the application unique identification of the target application, the access object information to be updated, and the permission information to be updated, the eSIM can update the application permission control information relatively quickly based on the control information update request.

To facilitate understanding of the access object information to be updated and the permission information to be updated, the target application applying for the access permission of “microphone” is used as an example in the following description. When the target application applies for the access permission of “microphone”, the access object information to be updated can be “microphone”, and the permission information to be updated can be “authorized” or “accessible” and other information.

In an alternative embodiment of the present application, the control information update request is sent by the server through the user device management system. Receiving the encrypted control information update request may comprise: receiving an encrypted device authentication instruction, and the device authentication instruction carries the signature information of the user device management system; decrypting the device authentication instruction to obtain the signature information of the user device management system; verifying the signature information of the user device management system; and establishing, in a case where the verification is successful, a secure channel with the server through the user device management system, where the secure channel can be used to receive the control information update request.

Based on the pre-stored signature certificate of the user device management system, the signature information of the user device management system in the received device authentication instruction can be verified. In a case where the verification is successful, it can be determined that a secure channel is established with the server through the user device management system. This can prevent malicious tampering of the application permission control information in the eSIM.

FIG. 5 is a schematic flowchart of updating the application permission control information of the eSIM. The process of updating the application permission control information of the eSIM may comprise steps S501 to S506.

In step S501, the eSIM receives the encrypted device authentication instruction and verifies the signature information of the user device management system in the decrypted device authentication instruction based on the pre-stored signature certificate of the user device management system.

In step S502, it is determined whether the verification of the user device is successful. In a case where the verification is successful, steps S503 to S506 shall be executed; or in a case where the verification is unsuccessful, the process ends.

In step S503, in a case where the verification of the user device is successful, the eSIM sends the encrypted response data to the user device management system so that the user device may verify the eSIM, in which the response data carries the signature information in the eSIM. The user device management system can decrypt the response data and verify the signature information of the decrypted response data based on the pre-stored signature certificate of the eSIM.

In step S504, it is determined whether the verification of the eSIM is successful. In a case where the verification is successful, steps S505 and S506 shall be executed; or in a case where the verification is unsuccessful, the process ends.

In step S505, in a case where the verification of the eSIM is successful, the user device may establish a secure channel with the server.

In step S506, the server updates the application permission control information in the eSIM through the user device management system.

Taking the target application as the executing subject in the following description, the eSIM-based user device control method in the embodiment of the present application will be introduced.

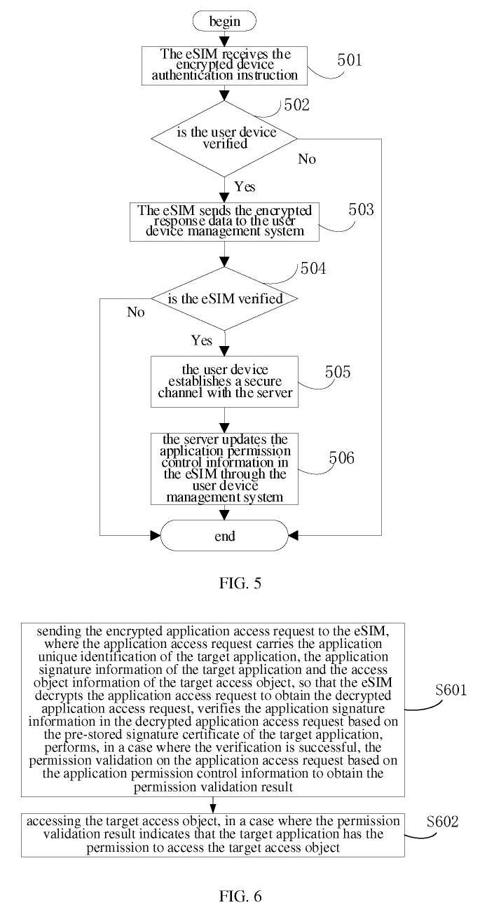

FIG. 6 is a schematic flowchart of the eSIM-based user device control method provided by an embodiment of the present application. As shown in FIG. 6, the eSIM-based user device control method provided in the embodiment of the present application may comprise step S601 and step S602.

In step S601, an encrypted application access request is sent to the eSIM, where the application access request carries the application unique identification of the target application, the application signature information of the target application and the access object information of the target access object, so that the eSIM may decrypt the application access request and obtain the decrypted application access request. The application signature information in the decrypted application access request can be verified based on the pre-stored signature certificate of the target application. In a case where the verification is successful, the application access request shall be permission validated based on the application permission control information, to obtain a permission validation result.

There can be various implementations for the target application to send the encrypted application access request to the eSIM.

In one embodiment, when the target application establishes a communication connection with the eSIM, the target application can send an application access request to the eSIM.

In another embodiment, the target application sends the encrypted application access request to the user device management system, which then sends the encrypted application access request to the eSIM.

There can be various implementations for the eSIM to send the permission validation result to the target application.

In an alternative embodiment of the present application, the eSIM directly sends the signed and encrypted permission validation result to the target application, and the target application receives the signed and encrypted permission validation result sent by the eSIM. In this way, the target application receives the permission validation result sent by the eSIM, which may prevent the permission validation result from being tampered with during the communication process.

In another embodiment, the eSIM sends the signed and encrypted permission validation result to the user device management system, and the user device management system sends the signed and encrypted permission validation result to the target application.

After receiving the signed and encrypted permission validation result sent by the eSIM, the target application decrypts the permission validation result and verifies the signature in the permission validation result based on the pre-stored signature certificate of the eSIM. In a case where the verification is successful, the target application may obtain the permission validation result.

In step S602, in a case where the permission validation result indicates that the target application has the permission to access the target access object, the target application may access the target access object.

In the embodiment of the present application, in a case where the identity verification of the target application is successful, based on the application permission control information that is pre-stored by the eSIM, whether the target application has the permission to access the target access object can be validated, a permission validation result can be obtained, and the permission validation result can be returned for the application access request. This may prevent the target application from tampering with its own access permissions, that is, prevent the target application from accessing the target access object without the permission to access the target access object, achieving secure management and control of the access permissions for the application. By presetting the application permission control information in the eSIM, different applications can be flexibly provided with different access permissions, realizing differentiated control and management of the application permissions.

In an alternative embodiment of the present application, the eSIM-based user device control method of the present application may further comprise: In a case where the permission validation result indicates that the target application does not have the permission to access the target access object, sending an access permission application request to the server, the access permission application request carries at least the application unique identification and access object information of the target application, so that the server sends a control information update request to the user device management system, and the control information update request is used to enable the user device management system to update the application permission control information that is pre-stored by the eSIM.

In a case where the target application does not have the permission to access the target access object, the target application can apply to the server for the permission to access the target access object, which enables the server to update the application permission control information that is stored in the eSIM, further allowing the server to centrally manage the access permissions for different devices and different applications.

Alternatively, the target application can send the access permission application request to the user device, that is, the target application can apply to the user device for the permission to access the target access object.

In an alternative embodiment of the present application, accessing the target access object may comprise: in a case where the permission validation result is used to indicate that the target application has the permission to access the target access object, obtaining the access permission data; generating the access instruction based on the access permission data and the application signature information of the target application; sending the access instruction to the user device management system, so that the user device management system verifies the application signature information in the access instruction based on the pre-stored signature certificate of the target application; in a case where the verification is successful, based on the obtained access permission data, sending the data corresponding to the target access object to the target application; and receiving the data of the target access object.

The user device management system verifies the application signature information in the access instruction based on the pre-stored signature certificate of the target application, so that the user device management system can further verify the legitimacy of the target application, preventing the illegal application from accessing the target access object of the user device based on the access instruction. In addition, the user device management system sends the data corresponding to the target access object to the target application based on the access permission data. This can prevent the target application from tampering with its own access permissions, that is, prevent the target application from accessing the target access object without permission.

In an alternative embodiment, the eSIM sends the signed and encrypted permission validation result to the user device management system, and the user device management system verifies the signature information in the permission validation result based on the pre-stored signature certificate in the eSIM. In a case wherein the verification is successful, the user device management system obtains the permission validation result. In a case where the permission validation result indicates that the target application has the permission to access the target access object, the user device management system can directly send the data of the target access object to the target application, which can reduce the number of passes between the target application and the user device, and save communication resources. In a case where the permission validation result indicates that the target application does not have the permission to access the target access object, the user device management system can directly refuse the target application to access the target access object, that is, the user device management system can send the no permission to access information to the target application.

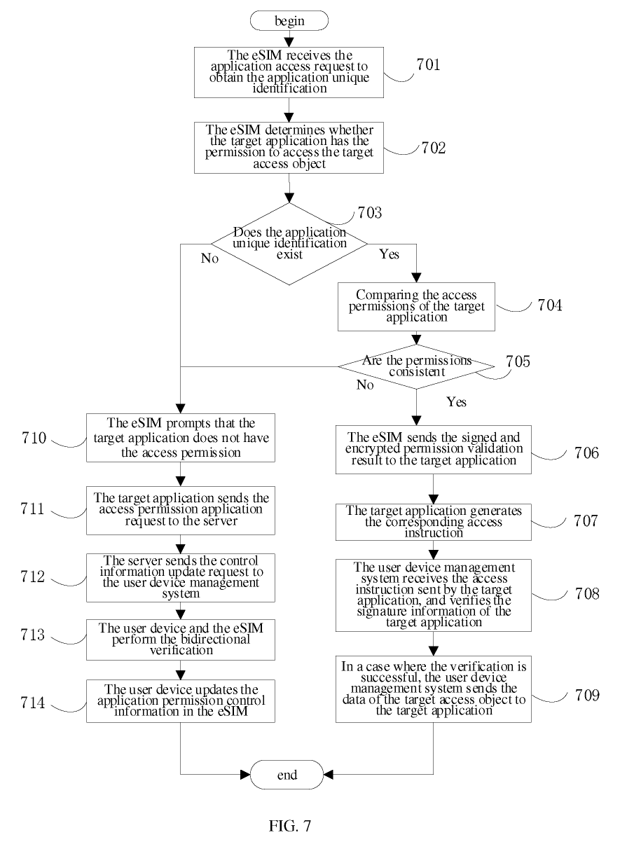

FIG. 7 is a schematic flowchart of determining the permission validation result based on the application permission control information. The process of determining the permission validation result may comprise steps S701 to S714.

In step S701, the eSIM receives the application access request and obtains the application unique identification.

In step S702, the eSIM determines whether the target application has the permission to access the target access object.

In step S703, it is determined whether the application unique identification exists. In a case where it exists, steps S704 to S709 shall be executed; or in a case where it does not exist, steps S710 to S714 shall be executed.

In step S704, in a case where the application unique identification exists, the eSIM compares the access permissions to the target application based on the application permission control information.

In step S705, it is determined whether the permissions are consistent. In a case where the permissions are consistent, steps S706 to S709 shall be executed; or in a case wherein the permissions are inconsistent, steps S710 to S714 shall be executed.

In step S706, in a case where the permissions are consistent, the eSIM sends the signed and encrypted permission validation result to the target application.

In step S707, in a case where the permission validation result is received, the target application decrypts the permission validation result and verifies the signature information in the permission validation result based on the pre-stored signature certificate of the eSIM. In a case where the verification is successful and the permission validation result indicates that the target application has access to the target access object, the target application generates the corresponding access instruction.

In step S708, the target application sends the access instruction to the user device management system. The user device management system receives the access instruction sent by the target application and verifies the signature information of the target application.

In step S709, in a case where the verification is successful, the user device management system sends the data of the target access object to the target application.

In step S710, in a case where the application unique identification does not exist and/or the permissions are inconsistent, the eSIM prompts that the target application does not have the access permission.

In step S711, the target application sends the access permission application request to the server.

In step S712, the server sends the control information update request to the user device management system.

In step S713, in a case where the user device management system receives the control information update request, the user device and the eSIM perform the bidirectional verification.

In step S714, if the bidirectional verification is successful, the user device updates the application permission control information in the eSIM.

Taking the user device as the executing subject in the following description, the eSIM-based user device control method of the present application will be introduced.

FIG. 8 is a schematic flowchart of the eSIM-based user device control method provided in an embodiment of the present application. As shown in FIG. 8, the eSIM-based user device control method provided in the embodiment of the present application may comprise steps S801 to S803.

In step S801, the access instruction sent by the target application is received.

In step S802, the access permission data is obtained based on the access instruction, and the access permission data is obtained in the case that the permission validation result indicates that the target application has the permission to access the target access object. The permission validation result is obtained by the eSIM decrypting the application access request, obtaining the decrypted application access request, verifying the application signature information in the decrypted application access request based on the pre-stored signature certificate of the target application, and In a case where the verification is successful, performing the permission validation on the application access request based on the application permission control information.

In step S803, in a case where the access permission data is obtained, the data of the target access object is sent to the target application.

In the embodiment of the present application, in a case where the identity verification of the target application is successful, based on the application permission control information that is pre-stored by the eSIM, whether the target application has the permission to access the target access object is successful, and the permission validation is obtained. This may prevent the target application from tampering with its own access permissions, that is, prevent the target application from accessing the target access object without the permission to access the target access object, achieving secure management and control of the access permissions for the application. By presetting the application permission control information in the eSIM, different applications can be flexibly provided with different access permissions, realizing differentiated control and management of the application permissions.

In an alternative embodiment of the present application, the access instruction at least carries the application signature information of the target application, and obtaining the access permission data based on the access instruction may comprise: based on the pre-stored signature certificate of the target application, verifying the application signature information in the access instruction; in a case where the verification is successful, determining whether the access permission data exists in the access instruction; and in a case where the access permission data exists in the access instruction, obtaining the access permission data.

The user device management system verifies the application signature information in the access instruction based on the pre-stored signature certificate of the target application, allowing the user device management system to verify the identity of the target application relatively quickly. In a case where the verification is successful, it is determined whether the access permission data exists in the access instruction. In a case where the access permission data exists in the access instruction, the access permission data is obtained. Subsequently, the user device management system can determine that the target application has the permission to access the target access object based on the access permission data, and send the data corresponding to the target access object to the target application.

In an alternative embodiment of the present application, the eSIM-based user device control method of the present application may further comprise: receiving the encrypted control information update request, where the control information update request is used to update the application permission control information that is pre-stored by the eSIM; updating the pre-stored application permission control information in the eSIM based on the encrypted control information update request.

Based on the encrypted control information update request, the application permission control information pre-stored by the eSIM is updated. This not only realizes the update of the application permission control information, but also enables the update of the application permission control information securely.

In an alternative embodiment of the present application, receiving the encrypted control information update request may comprise: sending the encrypted device authentication instruction to the eSIM, so that the eSIM decrypts the device authentication instruction, obtains the signature information of the user device management system, and verifies the signature information of the user device management system based on the pre-stored signature certificate of the user device management system, that is, in a case where the verification is successful, the eSIM sends the encrypted response data to the user device management system; receiving by the user device management system the encrypted response data sent by the eSIM, where the response data carries the signature information of the eSIM; verifying by the user device management system the signature information in the response data based on the pre-stored signature certificate of the eSIM; and in a case where the verification is successful, establishing by the user device a secure channel to the server, where the secure channel is used to receive the control information update request.

In a case where the bidirectional authentication between the user device and the eSIM is successful, the user device and the server establish the secure channel. That is, the server updates the application permission control information in the eSIM through the user device. This realizes the update of the application permission control information securely, preventing the illegal or malicious tampering with the application permission control information in the eSIM.

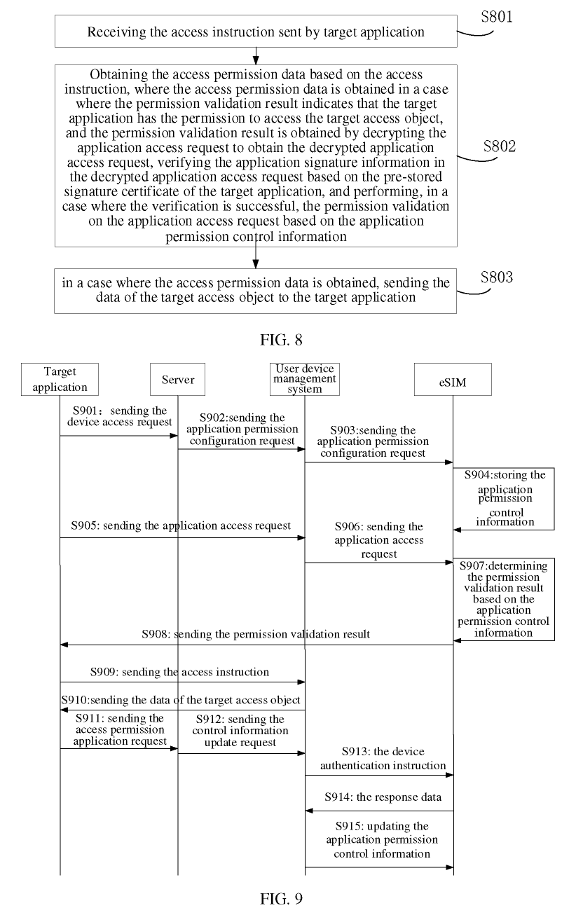

For ease of understanding, the embodiment further explains the eSIM-based user device control method in the application based on FIG. 9. The eSIM-based user device control method may comprise steps S901 to S915.

In step S901, the target application sends a device access request to the server. The device access request carries the application unique identification of the target application and the application signature information of the target application.

In step S902, the server may determine the application permission control information corresponding to the target application based on the application unique identification of the target application. The server sends the encrypted application permission configuration request carrying the application permission control information to the user device management system.

In step S903, the user device management system sends the encrypted application permission configuration request to the eSIM.

In step S904, the eSIM decrypts the application permission configuration request, obtains the application permission control information, and stores the application permission control information. The application permission control information comprise the application unique identification, the access object information and the permission information corresponding to the application unique identification.

In step S905, the target application sends an application access request to the user device management system.

In step S906, the user device management system sends an application access request to the eSIM.

In step S907, the eSIM determines the permission validation result based on the application permission control information. Specifically, the eSIM decrypts the application access request, obtains the decrypted application access request, and verifies the application signature information in the decrypted application access request based on the pre-stored signature certificate of the target application. In a case where the verification is successful, based on the application permission control information, the eSIM performs the permission validation on the application access request, and obtains the permission validation result.

In step S908, the eSIM sends the signed and encrypted permission validation result to the target application. In a case where the permission validation result indicates that the target application has the permission to access the target access object, steps S909 and S910 shall be executed. In a case where the permission validation result indicates that the target application does not have the permission to access the target access object, steps S911 to S915 shall be executed.

In step S909, in a case where the permission validation result indicates that the target application has the permission to access the target access object, the target application obtains the access permission data. The target application generates an access instruction based on the access permission data and the application signature information of the target application, and sends the access instruction to the user device management system.

In step S910, in a case where the access instruction is received, the user device management system verifies the signature information in the access instruction based on the pre-stored signature certificate of the target application. In a case where the verification is successful, the user device management system sends the data of the target access object to the target application.

In step S911, in a case where the permission validation result indicates that the target application does not have the permission to access the target access object, the target application sends the access permission application request to the server.

In step S912, the server sends a control information update request to the user device management system.

In step S913, the user device management system sends a device authentication instruction to the eSIM. The eSIM decrypts the device authentication instruction, obtains the signature information of the user device management system, and verifies the signature information in the device authentication instruction based on the pre-stored signature certificate of the user device management system.

In step S914, in a case where the verification is successful, the eSIM sends the response data to the user device management system. The user device management system verifies the signature information in the response data based on the pre-stored signature certificate of the eSIM.

In step S915, in a case where the verification is successful, the server establishes a secure channel with the user device to update the application permission control information in the eSIM.

For ease of understanding, the embodiment further explains the eSIM-based user device control method in the application based on FIG. 10. The eSIM-based user device control method may comprise steps S1001 to S1013.

In step S1001, the target application sends a device access request to the user device management system. The device access request carries the application unique identification of the target application and the application signature information of the target application.

In step S1002, the user device management system may determine the application permission control information corresponding to the target application based on the unique application identification of the target application. The user device management system sends the encrypted application permission configuration request carrying the application permission control information to the eSIM.

In step S1003, the eSIM decrypts the application permission configuration request, obtains the application permission control information, and stores the application permission control information.

In step S1004, the target application sends an application access request to the user device management system.

In step S1005, the user device management system sends an application access request to the eSIM.

In step S1006, the eSIM determines the permission validation result based on the application permission control information. Specifically, the eSIM decrypts the application access request, obtains the decrypted application access request, and verifies the application signature information in the decrypted application access request based on the pre-stored signature certificate of the target application. In a case where the verification is successful, based on the application permission control information, the eSIM performs permission validation on the application access request, and obtain the permission validation result.

In step S1007, the eSIM sends the signed and encrypted permission validation result to the target application. In a case where the permission validation result indicates that the target application has the permission to access the target access object, steps S1008 and S1009 shall be executed. In a case where the permission validation result indicates that the target application does not have the permission to access the target access object, steps S1010 to S1013 shall be executed.

In step S1008, in a case where the permission validation result indicates that the target application has the permission to access the target access object, the target application obtains the access permission data. The target application generates an access instruction based on the access permission data and the application signature information of the target application, and sends the access instruction to the user device management system.

In step S1009, in a case where the access instruction is received, the user device management system verifies the signature information in the access instruction based on the pre-stored signature certificate of the target application. In a case where the verification is successful, the user device management system sends the data of the target access object to the target application.

In step S1010, in a case where the permission validation result indicates that the target application does not have the permission to access the target access object, the target application sends an access permission application request to the user device management system.

In step S1011, the user device management system sends a device authentication instruction to the eSIM. The eSIM decrypts the device authentication instruction, obtains the signature information of the user device management system, and verifies the signature information in the device authentication instruction based on the pre-stored signature certificate of the user device management system.

In step S1012, in a case where the verification is successful, the eSIM sends the response data to the user device management system. The user device management system verifies the signature information in the response data based on the pre-stored signature certificate of the eSIM.

In step S1013, in a case where the verification is successful, the server establishes a secure channel with the user device to update the application permission control information in the eSIM.

It should be noted that the eSIM-based user device control apparatus is the apparatus corresponding to the above-mentioned eSIM-based user device control method. All the implementations in the above method embodiments are applicable to the embodiments of the apparatus, and may also achieve the same technical effects, which will not be described again here.

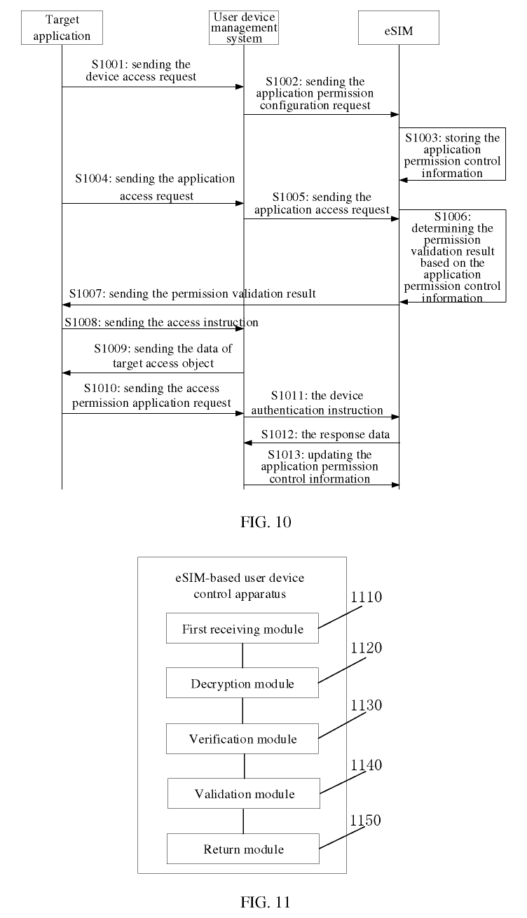

Based on the same inventive concept, the embodiments of the present application further provide an eSIM-based user device control apparatus. The eSIM-based user device control apparatus can be applied to the eSIM, and the eSIM may pre-store the application permission control information, and the application permission control information comprises the application unique identification, the access object information and the permission information corresponding to the application unique identification; specifically, the eSIM-based user device control apparatus provided in the embodiment of the present application will be described in detail with reference to FIG. 11.

FIG. 11 is a schematic structural diagram of the eSIM-based user device control apparatus provided in an embodiment of the present application. The eSIM-based user device control apparatus may comprise a first receiving module 1110, a decryption module 1120, a verification module 1130, a validation module 1140 and a return module 1150.

The first receiving module 1110 is used to receive an encrypted application access request, where the application access request carries the application unique identification of the target application, the application signature information of the target application, and the access object information of the target access object.

The decryption module 1120 is used to decrypt the application access request and obtain the decrypted application access request.

The verification module 1130 is used to verify the application signature information in the decrypted application access request based on the pre-stored signature certificate of the target application.

The validation module 1140 is used to perform the permission validation on the application access request based on the application permission control information In a case where the verification is successful, and obtain the permission validation result, and the permission validation result is used to indicate whether the target application has access to the target access object permission.

The return module 1150 is used to return the permission validation result for the application access request.

In one embodiment, the return module can be used to sign and encrypt the permission validation result to obtain the signed and encrypted permission validation result; the signed and encrypted permission validation result is sent to the target application, so that the target application decrypts the signed and encrypted permission validation result, and verifies the signature information in the decrypted permission validation result based on the pre-stored signature certificate of the eSIM. After the verification is successful, the permission validation result is obtained.

In one embodiment, the eSIM-based user device control apparatus of the present application may further comprise a third receiving module, a decryption module and a first update module. The third receiving module can be used to receive an encrypted control information update request, where the control information update request carries at least the application unique identification of the target application, the access object information to be updated, and the permission information to be updated; the decryption module can be used to decrypt the control information update request and obtain the decrypted control information update request; and the first update module can be used to update the application permission control information based on the decrypted control information update request.

In one embodiment, the control information update request is sent by the server through the user device management system, and the third receiving module can further be used to receive the encrypted device authentication instruction, where the device authentication instruction carries the signature information of the user device management system; decrypt the device authentication instruction and obtain the signature information of the user device management system; and verify the signature information of the user device management system. In a case where the verification is successful, it is determined to establish a secure channel with the server through the user device management system, and the secure channel is used to receive the control information update request.

In one embodiment, the eSIM-based user device control apparatus of the present application may further comprise a fourth receiving module that can be used to receive an encrypted application permission configuration request, where the application permission configuration request carries the application permission control information, the application permission configuration request is sent by the server through the user device management system, and the application permission control information is generated by the server based on the device access request sent by the target application, and is stored.

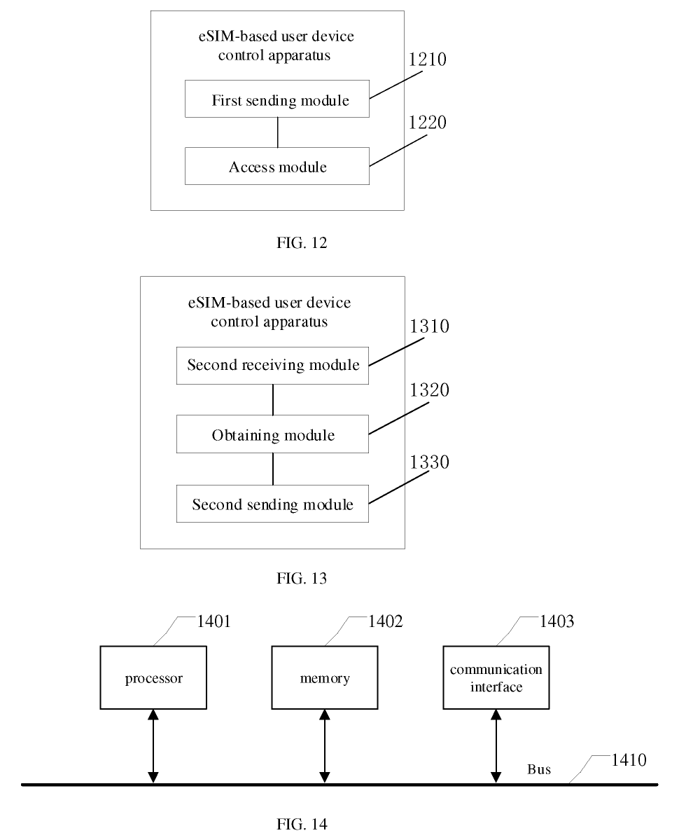

Based on the same inventive concept, the embodiments of the present application further provide an eSIM-based user device control apparatus. The eSIM-based user device control apparatus is applied to a target application, and the target application runs on the user device. The user device comprises an eSIM, the eSIM pre-stores the application permission control information, and the application permission control information comprises an application unique identification and the access object information and the permission information corresponding to the application unique identification. Specifically, the eSIM-based user device control apparatus provided in the embodiments of the present application will be described in detail with reference to FIG. 12.

FIG. 12 is a schematic structural diagram of the eSIM-based user device control apparatus provided in an embodiment of the present application. The eSIM-based user device control apparatus may comprise a first sending module 1210 and an access module 1220.

The first sending module 1210 is used to send an encrypted application access request to the eSIM, where the application access request carries the application unique identification of the target application, the application signature information of the target application, and the access object information of the target access object, so that the eSIM decrypts the application access request, obtains the decrypted application access request, and verifies the application signature information in the decrypted application access request based on the pre-stored signature certificate of the target application. In a case where the verification is successful, the first sending module 1210 performs the permission validation based on the application permission control information, and obtains the permission validation result.

The access module 1220 is used to access the target access object In a case where the permission validation result indicates that the target application has the permission to access the target access object.

In one embodiment, the eSIM-based user device control apparatus of the present application may further comprise a fifth receiving module. The fifth receiving module is used to receive the signed and encrypted permission validation result sent by the eSIM before accessing the target access object.

In one embodiment, the eSIM-based user device control apparatus of the present application may further comprise a fourth sending module. The fourth sending module can be used to send an access permission application request to the server In a case where the permission validation result indicates that the target application does not have the permission to access the target access object, and the access permission application request carries at least the application unique identification and the access object information of the target application, so that the server sends a control information update request to the user device management system, and the control information update request is used to enable the user device management system to update the application permission control information that is pre-stored by the eSIM.

In one embodiment, the access module can further be used to obtain the access permission data In a case where the permission validation result is used to indicate that the target application has the permission to access the target access object, generate an access instruction based on the access permission data and the application signature information of the target application, send the access instruction to the user device management system, so that the user device management system verifies the application signature information in the access instruction based on the pre-stored signature certificate of the target application. In a case where the verification is verified, based on the obtained access permission data, send the data corresponding to the target access object to the target application. The data of the target access object shall be received.

Based on the same inventive concept, the embodiments of the present application further provide an eSIM-based user device control apparatus. The eSIM-based user device control apparatus is applied to the user device, and the user device runs the target application. The user device comprise the eSIM, and the eSIM pre-stores the application permission control information, and the application permission control information comprises the application unique identification, the access object information corresponding to the application unique identification, and the permission information. Specifically, the eSIM-based user device control apparatus provided by the embodiment of the present application will be described in detail with reference to FIG. 13.

FIG. 13 is a schematic structural diagram of the eSIM-based user device control apparatus provided in an embodiment of the present application. The eSIM-based user device control apparatus may comprise a second receiving module 1310, an obtaining module 1320 and a second sending module 1330.

The second receiving module 1310 is used to receive the access instruction sent by the target application.

The obtaining module 1320 is used to obtain the access permission data based on the access instruction. The access permission data is obtained In a case where the permission validation result indicates that the target application has the permission to access the target access object. The permission validation result is obtained by the eSIM decrypting the application access request to obtain the decrypted application access request, verifying the application signature information in the decrypted application access request based on the pre-stored signature certificate of the target application, and In a case where the verification is successful, performing the permission validation based on the application permission control information.

The second sending module 1330 is used to send the data of the target application object to the target application In a case where the access permission data is obtained.

In one embodiment, the access instruction at least carries the application signature information of the target application, and the obtaining module can further be used to verify the application signature information in the access instruction based on the pre-stored signature certificate of the target application, in a case where the verification is successful, determine whether the access permission data exists in the access instruction, and In a case where the access permission data exists in the access instruction, obtain the access permission data.

In one embodiment, the eSIM-based user device control apparatus of the present application may further comprise a sixth receiving module and a first update module. The sixth receiving module can be used to receive an encrypted control information update request, where the control information update request is used to update the application permission control information that is pre-stored by the eSIM, and the first update module can be used to update the application permission control information that is pre-stored by the eSIM based on the encrypted control information update request.

In one embodiment, the sixth receiving module can further be used to send an encrypted device authentication instruction to the eSIM, so that the eSIM decrypts the device authentication instruction, obtains the signature information of the user device management system, and verifies the signature information of the user device management system based on the pre-stored signature certificate of the user device management system; to receive the encrypted response data sent by the eSIM, where the response data carries the signature information of the eSIM; to verify the signature information in the response data based on the pre-stored signing certificate of the eSIM; and In a case where the verification is successful, to establish a secure channel with the server, where the secure channel is used to receive the control information update request.

FIG. 14 shows a schematic diagram of the hardware structure of the user device provided in an embodiment of the present application.

The user device may comprise an eSIM, a processor 1401, and a memory 1402 storing the computer-program instructions. Specifically, the above-mentioned processor 1401 may comprise a central processing unit (CPU), or an Application Specific Integrated Circuit (ASIC), or one or more integrated circuits that may be configured to implement the embodiments of the present application.

The memory 1402 may comprise a mass storage for data or instructions. By way of example and not a limitation, the memory 1402 may comprise a Hard Disk Drive (HDD), a floppy disk drive, a flash memory, an optical disc, a magneto-optical disc, magnetic tape, or a Universal Serial Bus (USB) drive or a combination of two or more of them. The memory 1402 may comprise a removable or non-removable (or fixed) media, if appropriate. The memory 1402 may be internal or external to the integrated gateway disaster recovery facility, if appropriate. In particular embodiments, the memory 1402 is a non-volatile, solid-state memory.

The memory may comprise a read-only memory (ROM), a random-access memory (RAM), magnetic disk storage media devices, optical storage media devices, flash memory devices, or electrical, optical, or other physical/tangible memory storage devices. Thus, in general, the memory comprises one or more tangible (non-transitory) computer-readable storage media (e.g., a memory device) encoded with software comprising computer executable instructions which, when the software is executed (e.g., by one or more processors), is operable to perform the operations described with reference to the method according to any aspect of the present application.

The processor 1401 is configured to read and execute the computer program instructions stored in the memory 1402 to implement any one of the eSIM-based user device control methods in the above embodiments.

In one example, the user device may further comprise a communication interface 1403 and a bus 1410. Among them, as shown in FIG. 14, the processor 1401, the memory 1402, and the communication interface 1403 are connected through the bus 1410 and complete communication with each other.

The communication interface 1403 is mainly used to implement the communication between the modules, apparatus, units and/or devices in the embodiments of the present application.

The bus 1410 comprises hardware, software, or couples components of both to each other. By way of example but not a limitation, the bus may comprise an Accelerated Graphics Port (AGP) or other graphics bus, an Enhanced Industry Standard Architecture (EISA) bus, a Front-side Bus (FSB), a HyperTransport (HT) interconnect, an Industry Standard Architecture (ISA) bus, an InfiniBand interconnect, a low pin count (LPC) bus, a memory bus, a Micro Channel Architecture (MCA) bus, a Peripheral Component Interconnect (PCI) bus, a PCI-Express (PCI-X) bus, a Serial Advanced Technology Attachment (SATA) bus, a Video Electronics Standards Association local (VLB) bus, or other suitable bus, or a combination of two or more of them. The bus 1410 may comprise one or more buses, if appropriate. Although specific buses are described and illustrated in the embodiments herein, any suitable bus or interconnect can be considered in the present application.

The user device can execute the eSIM-based user device control method in the embodiments of the present application, thereby implementing the eSIM-based user device control method described in conjunction with FIGS. 1 to 10.

In addition, in combination with the eSIM-based user device control method in the above embodiments, the embodiments of the present application can provide a computer-storage medium for the implementation, storing computer program instructions that, when the computer program instructions are executed by the processor, may implement any eSIM-based user device control method in the above embodiments.

The embodiments of the present application further provide a computer-program product comprising a computer program which, when processed and executed by one or more processors, may implement any of the eSIM-based user device control method in the above embodiments.

It should be understood that the present application is not limited to the specific arrangements and processes described above and illustrated in the drawings. For the sake of brevity, detailed descriptions of the well-known methods are omitted herein. In the above embodiments, several specific steps are described and shown as examples. However, the method process of the present application shall be not limited to the specific steps described and shown. Those skilled in the art can make various changes, modifications and additions, or change the order between the steps after understanding the spirit of the present application.

The functional blocks shown in the structural block diagrams described above may be implemented as hardware, software, firmware, or a combination thereof. When implemented in hardware, it may be, for example, an electronic circuit, an application-specific integrated circuit (ASIC), appropriate firmware, a plug-in, a function card, etc. When implemented in software, the elements of the present application are programs or code segments used to perform the required tasks. The program or code segments can be stored in a machine readable medium or sent over a transmission medium or communication link by a data signal carried in a carrier wave. A "machine readable medium" may include any medium that can store or transfer information. Examples of machine-readable media include electronic circuits, semiconductor memory devices, ROM, flash memory, erasable ROM (EROM), floppy disks, CD-ROMs, optical disks, hard disks, fiber optic media, radio frequency (RF) links, etc. The code segments may be downloaded via a computer network such as the Internet, an intranet, or the like.

It should also be noted that the exemplary embodiments mentioned in this application describe some methods or systems based on a series of steps or devices. However, the present application is not limited to the order of the above steps. That is to say, the steps can be executed in the order mentioned in the embodiments, or can be different from the order in the embodiments, or several steps can be executed simultaneously.

Aspects of the present application are described above with reference to flowchart illustrations and/or block diagrams of methods, apparatus (systems) and computer program products according to embodiments of the application. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable implementation of the functions/acts specified in the flowchart and/or block diagram block or blocks. Such processors may be, but are not limited to, general purpose processors, special purpose processors, application specific processors, or field programmable logic circuits. It will also be understood that each block of the block diagrams and/or flowchart illustration, and combinations of blocks in the block diagrams and/or flowchart illustration, can also be implemented by special purpose hardware that performs the specified functions or acts, or combinations of special purpose hardware and computer instructions.

The above is only a specific implementation of the present application. Those skilled in the art can clearly understand that for the convenience and simplicity of description, the specific working processes of the systems, modules and units described above can refer to the aforementioned method embodiments. Corresponding processes in will not be described again here. It should be understood that the protection scope of the present application is not limited thereto. Any person familiar with the technical field can easily think of various equivalent modifications or substitutions within the technical scope disclosed in the present application, and these modifications or substitutions should be covered within the protection scope of this application.

1. An eSIM-based user device control method, wherein, the method is applied to an eSIM, the eSIM pre-stores an application permission control information, and the application permission control information comprises an application unique identification, an access object information and a permission information corresponding to the application unique identification; the method comprises:
receiving an encrypted application access request, wherein the application access request carries the application unique identification of a target application, an application signature information of the target application, and an access object information of a target access object;
decrypting the application access request to obtain the decrypted application access request;
verifying the application signature information in the decrypted application access request based on a pre-stored signature certificate of the target application;
in a case where the verification is successful, performing a permission validation on the application access request based on the application permission control information to obtain a permission validation result, and the permission validation result is used to indicate whether the target application has the permission to access the target access objects;
returning the permission validation result for the application access request.

2. The method according to claim 1, wherein, returning the permission validation result for the application access request comprises:
signing and encrypting the permission validation result to obtain the signed and encrypted permission validation result;
sending the signed and encrypted permission validation result to the target application, so that the target application decrypts the signed and encrypted permission validation result, verifies the signature information in the decrypted permission validation result based on the pre-stored signature certificate of the eSIM, and obtains the permission validation result after the verification is successful.

3. The method according to claim 1, wherein, the method further comprises:
receiving an encrypted control information update request, wherein the control information update request at least carries the unique application identification of the target application, the access object information to be updated, and the permission information to be updated;
decrypting the control information update request to obtain the decrypted control information update request; and
updating the application permission control information based on the decrypted control information update request.

4. The method according to claim 3, wherein, the control information update request is sent by the server through a user device management system;
receiving the encrypted control information update request, comprises:
receiving an encrypted device authentication instruction, wherein the device authentication instruction carries a signature information of the user device management system;
decrypting the device authentication instruction to obtain the signature information of the user device management system;
verifying the signature information of the user device management system; and
in a case where the verification is successful, establishing a secure channel with the server through the user device management system, wherein the secure channel is used to receive the control information update request.

5. The method according to claim 1, wherein, the process that the eSIM pre-stores the application permission control information comprises:
receiving an encrypted application permission configuration request, wherein the application permission configuration request carries the application permission control information, the application permission configuration request is sent by the server through the user device management system, and the application permission control information is generated by the server based on the device access request sent by the target application; and
storing the application permission control information.

6. An eSIM-based user device control method, wherein, the method is applied to a target application, the target application runs on a user device, the user device comprises an eSIM, the eSIM pre-stores an application permission control information, and the application permission control information comprises an application unique identification, an access object information and a permission information corresponding to the application unique identification; the method comprises:
sending an encrypted application access request to the eSIM, wherein the application access request carries the application unique identification of the target application, the application signature information of the target application and the access object information of the target access object, so that the eSIM decrypts the application access request to obtain the decrypted application access request, verifies the application signature information in the decrypted application access request based on the pre-stored signature certificate of the target application, and in a case where the verification is successful, performs a permission validation on the application access request based on the application permission control information to obtain the permission validation result;
accessing the target access object in a case where the permission validation result indicates that the target application has permission to access the target access object.

7. The method according to claim 6, wherein, before accessing the target access object, the method further comprises:
receiving the signed and encrypted validation result sent by the eSIM.

8. The method according to claim 6, wherein, the method further comprises:
sending an access permission application request to the server in a case where the permission validation result indicates that the target application does not have the permission to access the target access object, wherein the access permission application request carries at least the application unique identification and the access object information of the target application, so that the server sends a control information update request to the user device management system, and the control information update request is used to enable the user device management system to update the application permission control information that is pre-stored by the eSIM.

9. The method according to claim 6, wherein, accessing the target access object comprises:
obtaining access permission data in a case that the permission validation result is used to indicate that the target application has the permission to access the target access object;
generating an access instruction based on the access permission data and an application signature information of the target application;
sending the access instruction to the user device management system, so that the user device management system verifies the application signature information in the access instruction based on the pre-stored signature certificate of the target application, and sending data corresponding to the target access object to the target application, in a case where the verification is successful, based on the obtained access permission data; and
receiving the data of the target access object.

10. An eSIM-based user device control method, wherein, the method is applied to a user device, the user device runs a target application, the user device comprises an eSIM, the eSIM pre-stores an application permission control information, and the application permission control information comprises an application unique identification, an access object information and a permission information corresponding to the application unique identification; the method comprises:
receiving an access instruction sent by the target application;
obtaining access permission data based on the access instruction, wherein the access permission data is obtained in a case where the permission validation result indicates that the target application has the permission to access the target access object, and the permission validation result is obtained by decrypting, by the eSIM, the application access request to obtain the decrypted application access request, verifying the application signature information in the decrypted application access request based on the pre-stored signature certificate of the target application, and performing a permission validation on the application access request based on the application permission control information in a case where the verification is successful; and
sending the data of the target access object to the target application in a case where the access permission data is obtained.

11. The method according to claim 10, wherein, the access instruction at least carries the application signature information of the target application, and obtaining the access permission data based on the access instruction comprises:
verifying the application signature information in the access instruction based on a pre-stored signature certificate of the target application;
determining, in a case where the verification is successful, whether the access permission data exists in the access instruction; and
obtaining, in a case where the access permission data exists in the access instruction, the access permission data.

12. The method according to claim 10, wherein, the method further comprises:
receiving an encrypted control information update request, wherein the control information update request is used to update the application permission control information that is pre-stored by the eSIM; and
updating, based on the encrypted control information update request, the application permission control information that is pre-stored by the eSIM.

13. The method according to claim 12, wherein, receiving the encrypted control information update request comprises:
sending an encrypted device authentication instruction to the eSIM, so that the eSIM decrypts the device authentication instruction to obtain the signature information of the user device management system, and verifying the signature information of the user device management system based on the pre-stored signature certificate of the user device;
receiving encrypted response data sent by the eSIM, wherein the response data carries the signature information of the eSIM;
verifying the signature information in the response data based on a pre-stored signature certificate of the eSIM; and
establishing, in a case where the verification is successful, a secure channel with a server, wherein the secure channel is used to receive the control information update request.

14. An eSIM-based user device control system, wherein, the system comprises a user device and a server, the user device runs a target application, the user device comprises an eSIM, the eSIM pre-stores an application permission control information, and the application permission control information comprises an application unique identification, an access object information and a permission information corresponding to the application unique identification; wherein,
the server is configured to generate the application permission control information based on the device access request sent by the target application, and send the application permission control information to the eSIM through the user device management system;
the eSIM is configured to receive an encrypted application access request, decrypt the application access request to obtain the decrypted application access request, verify the application signature information in the decrypted application access request based on the pre-stored signature certificate of the target application, and perform, in a case where the verification is successful, a permission validation on the application access request based on the application permission control information to obtain a permission validation result, wherein the application access request carries the application unique identification of the target application, the application signature information of the target application and the access object information of the target access object, and the permission validation result indicates whether the target application has the permission to access the target access object.

15. A non-transitory computer-readable storage medium, wherein, the computer-readable storage medium stores computer program instructions which, when executed by a processor, implements the eSIM-based user device control method according to claim 1.

16. A user device, wherein, the user device comprises: an eSIM, a processor, and a memory storing computer program instructions; and
the processor, when executes the computer program instructions, implements the eSIM-based user device control method according to claim 1.
